(19) United States
(12) Patent Application Publication
(10) Pub. No.: US 2012/0234933 A1
(43) Pub. Date: Sep. 20, 2012

(54) PAINT SPRAYING DEVICE AND METHOD FOR APPLYING SUCH A DEVICE

(75) Inventor: Gilles Duprat, Belfort (FR)

(73) Assignee: FAURECIA BLOC AVANT, Nanterre (FR)

(21) Appl. No.: 13/424,075

(22) Filed: Mar. 19, 2012

(30) Foreign Application Priority Data
Mar. 18, 2011 (FR) 1152258

(51) Int. Cl. B05B 7/08; B05B 1/14

(52) U.S. Cl. 239/1; 239/549

(57) ABSTRACT

The disclosure relates to a paint spraying device including a body forming a support. According to the disclosure, the spraying device comprises at least two nozzles provided with paint spraying means and mounted on said body and at least two paint reservoirs, each nozzle being connected through supply means to a distinct paint reservoir.

### CROSS REFERENCE TO RELATED APPLICATIONS

This patent application claims priority to French patent application no. FR1152258, filed Mar. 18, 2011, the disclosure of which is herein incorporated by reference in its entirety.

### BACKGROUND

The present disclosure relates to a paint spraying device of the type including a body forming a support and to a method for applying such a device.

Such a device may notably be borne by a robot arm adapted for displacing the body.

Paint spraying devices conventionally used in industry, for example in the automotive industry, include one or more nozzles positioned on the body forming a support and connected through supply means to a paint reservoir.

Such spraying devices, notably in the case of a support receiving several nozzles, give the possibility of painting parts of a substantial size.

In the automotive industry, for example, a complete installation has at least three spraying devices, such as those mentioned above, each borne by a robot arm so that each device successively sprays the primer, base and varnish layers.

Such an installation has many drawbacks, it is bulky, each robot equipped with a spraying device requires non-negligible space in a factory, and is energy-consuming.

Further, it is not adapted to productions with low throughput, each spraying device and therefore each robot which supports it, are very costly in investment, and under-utilized.

One of the objects of the disclosure is to overcome the drawbacks above by proposing an economical device, particularly adapted for low throughput productions.

For this purpose, the object of this disclosure is a device of the aforementioned type comprising at least two nozzles provided with paint spraying means and mounted on said body and at least two paint reservoirs, each nozzle being connected through supply means to a distinct paint reservoir.

The device according to the disclosure may include one or more of the following features:

each nozzle may include a cylindrical body comprising a first end and a second one supporting paint spraying means, each first nozzle end being oriented towards the centre of the body forming a support and each second end being oriented towards the outside of the support;

the body forming a support may include a substantially planar surface with a circular shape;

the device may comprise three nozzles and three paint reservoirs;

the nozzles may be distributed over the surface so as to form between them an angle of 120°;

each paint reservoir may respectively contain a paint of the primer, base and varnish type;

each nozzle may be mounted on the body forming a support by means of a spacer including a first planar face attached onto the upper portion of the body and a second face supporting the nozzle;

the first planar face may form with the second face an angle comprised between 20 and 40°;

each second nozzle end may be raised relatively to the first end.

The disclosure also relates to a method for applying a paint spraying device according to the disclosure, characterized in that it comprises:

a first step for applying a first layer of paint carried out by means of a first nozzle connected to a first paint reservoir; followed by

a second step for applying a second layer of paint carried out by means of a second nozzle connected to a second paint reservoir.

The disclosure will be better understood upon reading the description which follows, only given as an example and made with reference to the appended drawings, wherein:

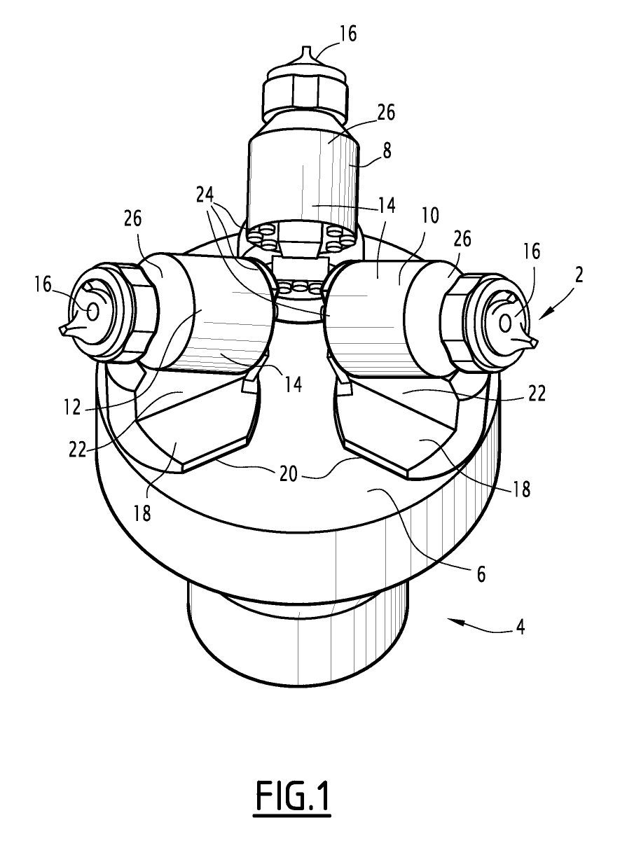

FIG. 1 illustrates a partial perspective view of a paint spraying device according to the disclosure;

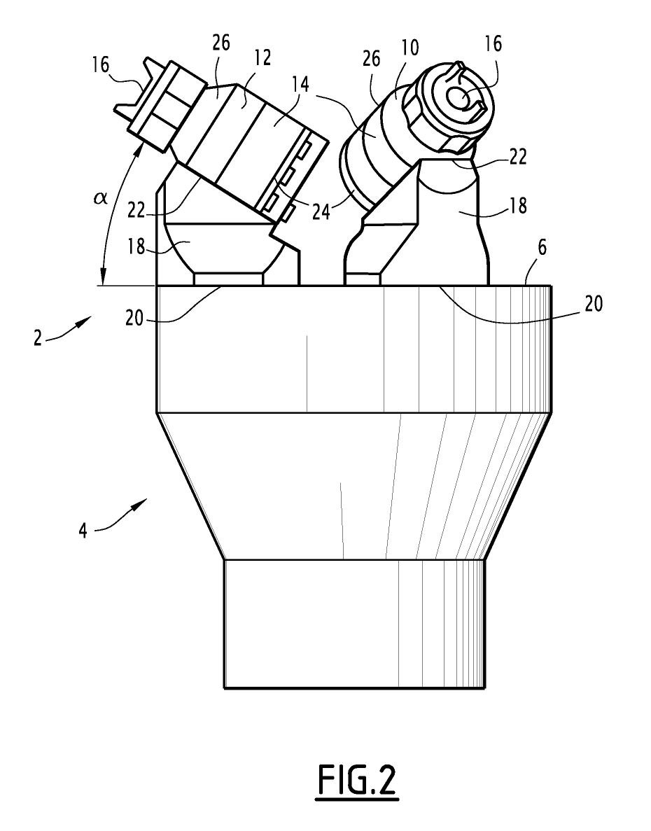

FIG. 2 is a sectional view of the device illustrated in FIG. 1; and

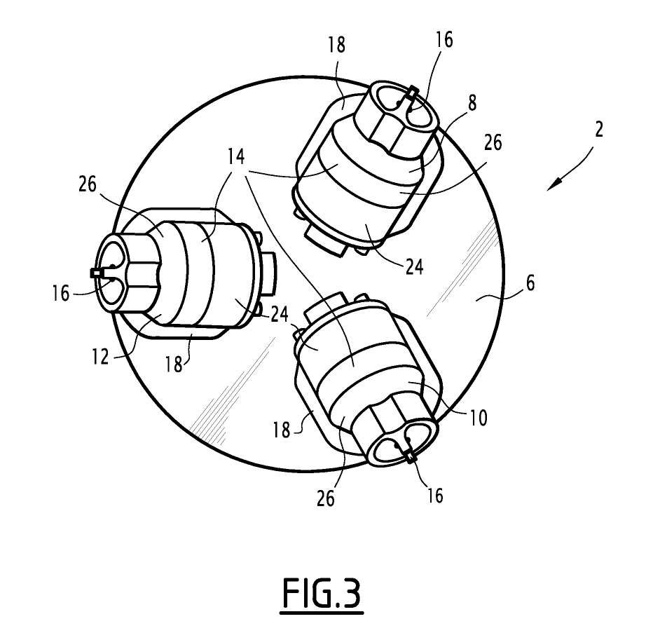

FIG. 3 is a top view of the spraying device illustrated in FIG. 1.

FIG. 1 illustrates a partial view of a paint spraying device 2.

The spraying device 2 includes a body 4 forming a support, the upper portion of which comprises a substantially planar surface 6 of circular shape. The body 4 forming a support may notably be born by a robot arm, not illustrated, adapted for displacing the body 4.

According to the disclosure, at least two nozzles allowing spraying of the paint with view to applying it on the part(s) to be painted, not shown, and provided for this purpose with spraying means 16, are positioned on the planar surface 6.

According to the exemplary embodiment illustrated in FIGS. 1 to 3, the spraying device includes three nozzles respectively referenced 8, 10, 12.

Preferably, the nozzles 8, 10, 12 fitting out the spraying device 2 are identical and each include a substantially cylindrical body 14 connected through paint supplying means to a paint reservoir in order to supply the spraying means 16 with paint.

Each nozzle is mounted on the body 4 forming a support by means of a spacer 18 including a first planar face 20 attached on the other portion of the body 4 and a second face 22 supporting the nozzle. The second face 22 is inclined relatively to the first face 20, so that the nozzle mounted on a spacer 18 is inclined relatively to the surface 6.

The spacers 18 are preferably identical.

The first planar face 20 forms with the second corresponding face 22 an angle a comprised between 20 and 40°. More particularly, the first planar face 20 and the second inclined face 22 form between them an angle a substantially equal to 30°.

In order to ensure proper positioning of the nozzles, each second face 22 includes a recess intended to receive a portion of the cylindrical body 14 of the nozzle. The recess has a shape which substantially mates that of a portion of the body 14 of the nozzle.

Each nozzle body has a first end 24 connected to the paint supply means and a second end 26 supporting the paint spraying means 16.

Alternatively, the first end 24 of the substantially cylindrical body may be free, the paint supply means then being positioned in the body of the spacer 18 so as to connect the paint reservoir to the paint spraying means 16.

Preferably, the nozzles 8, 10, 12 and the spacers 18 supporting the latter are regularly distributed over the upper circular surface 6 of the body 4 forming a support so as to form between them an angle of 120°.

The nozzles 8, 10, 12 are positioned on the upper portion 6 of the body of circular shape so that their first end 24 is each positioned in proximity to the centre of this upper portion. The ends 24 thus face each other, while the spray means 16, supported by the ends 26, are oriented towards the outside of the support 4.

Each nozzle is positioned in an identical way on the upper portion 6 of the body 4. Each nozzle, attached on the face 22 of a spacer 18 is inclined so that the end 26 supporting the spraying means 16 are raised relatively to the end 24.

According to the disclosure, each spraying means 16 is fed by an independent supply means, i.e. not connected to the other supply means ensuring supply of paint to the two other nozzles.

The supply means are for example formed by a pipe and a pump sucking up the paint from the reservoir and bringing it to the spraying means 16 laid out for spraying the paint at a predetermined pressure.

Also, each spraying means 16 is connected to an independent paint reservoir. Each reservoir may thus comprise among a non-exhaustive list, the following types of paint: a primer, a base or a varnish.

The paints used may notably be of the electrostatic type. This type of paint has the particularity of being ionized, while the part to be painted is grounded.

The spraying means 16 of each nozzle may be adapted to the paint to be sprayed, for example by modifying the spraying pressure or the size of the paint outlet orifices.

Thus, by means of the disclosure, a single robot arm may support several nozzles each connected to an independent paint reservoir. Each nozzle may then apply a different layer of paint.

Such an installation gives the possibility of strongly reducing the investment costs required for a paint installation.

Thus, in the case illustrated in FIGS. 1 to 3, where a single robot includes three nozzles each connected to a different paint reservoir, the costs are practically divided by three, if such an installation is compared with a conventional installation including three robots, each arm of which is provided with a single nozzle.

The use of a single robot then also gives the possibility of reducing the energy consumption of this installation.

Also, such an installation gives the possibility of strongly reducing the surface area required for its implantation.

Such an installation is particularly of interest in the case of an installation used for decorating parts or assemblies of parts, such as a body of a motor vehicle, produced in a small series.

1-8. (canceled)

9. A paint spraying device including a body forming a support, comprising three nozzles provided with paint spraying means and mounted on said body and three paint reservoirs, each nozzle being connected through supply means to a distinct paint reservoir, each paint reservoir respectively containing a paint of the primer, base and varnish type.

10. The spraying device according to claim 9, wherein each nozzle includes a cylindrical body comprising a first end and a second end supporting the paint spraying means, each first end being oriented towards the center of the body forming the support and each second end being oriented towards the outside of the support.

11. The spraying device according to claim 10, wherein the body forming a support includes a substantially planar surface with a circular shape.

12. The spraying device according to claim 11, wherein the nozzles are distributed over the surface so as to form between them an angle of 120°.

13. The spraying device according to claim 12, wherein each nozzle is mounted on the body forming a support by means of a spacer including a first planar face attached on the upper portion of the body and a second face supporting the nozzle.

14. The spraying device according to claim 13, wherein the first planar face forms with the second face an angle (a) comprised between 20 and 40°.

15. The spraying device according to claim 11, wherein each nozzle is mounted on the body forming a support by means of a spacer including a first planar face attached on the upper portion of the body and a second face supporting the nozzle.

16. The spraying device according to claim 15, wherein the first planar face forms with the second face an angle (a) comprised between 20 and 40°.

17. The spraying device according to claim 10, wherein each nozzle is mounted on the body forming a support by means of a spacer including a first planar face attached on the upper portion of the body and a second face supporting the nozzle.

18. The spraying device according to claim 17, wherein the first planar face forms with the second face an angle (a) comprised between 20 and 40°.

19. The spraying device according to claim 18, wherein each second nozzle end is raised relatively to the first end.

20. The spraying device according to claim 9, wherein the body forming a support includes a substantially planar surface with a circular shape.

21. The spraying device according to claim 20, wherein the nozzles are distributed over the surface so as to form between them an angle of 120°.

22. The spraying device according to claim 21, wherein each nozzle is mounted on the body forming a support by means of a spacer including a first planar face attached on the upper portion of the body and a second face supporting the nozzle.

23. The spraying device according to claim 22, wherein the first planar face forms with the second face an angle (a) comprised between 20 and 40°.

24. The spraying device according to claim 20, wherein each nozzle is mounted on the body forming a support by means of a spacer including a first planar face attached on the upper portion of the body and a second face supporting the nozzle.

25. The spraying device according to claim 24, wherein the first planar face forms with the second face an angle (a) comprised between 20 and 40°.

26. The spraying device according to claim 9, wherein each nozzle is mounted on the body forming a support by means of a spacer including a first planar face attached on the upper portion of the body and a second face supporting the nozzle.

27. The spraying device according to claim 26, wherein the first planar face forms with the second face an angle (a) comprised between 20 and 40°.

28. A method for applying paint using a paint spraying device, comprising the steps of:
providing a body forming a support;
providing three nozzles on the body;
providing paint spraying means associated with each nozzle;
providing multiple paint reservoirs;
providing supply means;
each nozzle being connected through supply means to a separate paint reservoir, and each of the multiple paint reservoirs containing at least one of a primer, base and varnish type;
applying a first layer of paint carried out by means of a first nozzle connected to a first paint reservoir; and
applying a second layer of paint carried out by means of a second nozzle connected to a second paint reservoir.
